(19) United States
(12) Patent Application Publication
(10) Pub. No.: US 2009/0098261 A1
(43) Pub. Date: Apr. 16, 2009

(54) A PREPARATION METHOD OF PROTEIN EXTRACTS FROM RICE BRAN

(76) Inventors: Hyun-Jun Park, Busan (KR); Sung-Wook Han, Incheon (KR); Dong-Yun Lee, Seoul (KR); Hong-Ki Kim, Incheon (KR); Hyun-Chul Jeong, Suwon-si (KR); Hyun-Ho Park, Incheon (KR)

Correspondence Address: BIRCH STEWART KOLASCH & BIRCH, PO BOX 747, FALLS CHURCH, VA, 22040-0747, US

(21) Appl. No.: 12/028,350

(22) Filed: Feb. 8, 2008

(30) Foreign Application Priority Data
Sep. 12, 2007 (KR) 10-2007-0092391

(51) Int. Cl. A23P 1/02; A23J 1/12

(52) U.S. Cl. 426/285; 426/656

(57) ABSTRACT

The present invention relates to a preparation method of protein extracts from rice bran which is comprising a process of pre-treating rice bran; producing de-fatted rice bran by removing fat from the pellet; a process of extracting protein from the de-fatted rice bran, generating protein solution; and a process of precipitating protein from the protein solution to obtain final protein extracts from rice bran.
The method of the present invention makes it possible to obtain lipid from rice bran, which has been wasted and used only as feed or compost due to fast rancidity and low stability, and to ultimately develop proteineous materials of high quality, non-GMO and no-allergy by extracting protein from the rice bran.
In addition, the present invention provides a method of recycling rice bran, which is wasted as a by-product, by adding values to the rice bran. And simultaneously the present invention provides a possibility of developing new product which can meet the customers' needs for safety in proteineous materials.

### TECHNICAL FIELD

The present invention relates to a preparation method of protein extracts from rice bran, more particularly, the preparation method comprising a process of pre-treating rice bran; producing de-fatted rice bran by removing fat from it; a process of extracting protein from the de-fatted rice bran, generating protein solution; and a process of precipitating protein from the protein solution to obtain final protein extracts from rice bran.

### BACKGROUND ART

The market of proteineous materials is estimated as much as approximately 2 billion dollars over the world. The major proteineous materials which are used widely in food industries are classified into the milk protein, animal protein, yolk protein, gelatin, single cell protein, soy bean protein, fish meat protein, gluten and vegetable protein, etc.

The proteineous materials are used for the purpose of nutrition or functionality.

With the purpose of nutrition, the proteineous materials are used to raise the nutritional balance or value and to increase the content of protein or amino acid in the products. One example is infant foods such as a milk powder or a weaning diet, health and functional foods for recovering from fatigue after exercise or for maintaining the nutritional balance of body. Recently, various proteineous materials are being used to raise the content of protein in ordinary foods together with the increase of interest on the intake of protein.

In addition, the purpose of functionality means using protein for applying its innate properties to products and the properties contains moisture/oil absorbing-capacity, foam forming capacity/foam stability, emulsifying capacity, gel forming capacity, etc.

Due to these properties, the proteineous materials are used in many products such as confectionery, bakery, meat processing, noodle, dessert.

Recently, the new trend is being observed in the protein market. In the past, the animal proteineous materials were widely used, but now the vegetable proteineous materials which is relatively safe are interested because of concerns on the sources of animal protein for mad-cow disease, foot-and-mouth disease, avian influenza, etc. together with the increase of the customer's interest on health. Due to the reason, the soybean protein market is growing big among the vegetable protein. However, soybean may cause allergy or cause the unrevealed problem by using GMO. Thus, the development of the new products free of the problems is required.

Among various materials from vegetables, rice, one of top 5 grains in the world, has plentiful supplies, has no allergy and has a well-balanced composition in spite of low content of protein. For these reason, it is used as a source of protein with good quality.

Recently, companies are developing the proteineous materials and its products derived from rice. However, as white rice or brown rice is expensive and its protein contents are low, the companies are suffering from price competitiveness. In order to solve this problem, many companies are obtaining protein by the method of removing starch from raw materials which comprise more than 90% starch through enzymatic treatment at high temperature and then extracting the residual protein.

However, the enzymatic treatment at high temperature may cause the denaturation of most protein in the raw materials, generating protein of poor physical properties. Because of the poor physical properties, most rice protein being produced now can not be used for the purpose of function even though they use high-priced white rice or brown rice.

Protein has a lot of physical properties, however, it is very susceptible to the temperature, thus can be easily denatured during its process. Once it is denatured or its bond is broken, its good physical properties disappear, thus, developing a new preparation method, which is echo-making and competitive in price, is required in order to develop proteineous materials of high quality which can be used widely.

Rice bran, a by-product produced in a polishing process of brown rice, has a very high nutritional value. However, it may be acidified and rotten rapidly due to high contents of fat, its various enzymes, environmental pollution during polishing. Also, as only 10% of rice bran by weight of total brown rice during polishing is distributed in actuality and its availabilities are low, most rice bran is wasted except for raw materials of feedstuff or compost. In spite of such disadvantages, rice bran, containing about 20% of fat and 16-18% of protein, has three times higher in contents compared to white rice or brown rice and therefore, it is very good raw material in food nutritionally.

In spite of that, the method of extracting protein from the rice bran has not be disclosed or known publicly anywhere from now on.

### DISCLOSURE

### [Technical Problem]

The objective of the present invention is to provide the preparation method of non-denatured proteineous materials of high quality and purity by using rice bran, a by-product produced in a polishing process of brown rice as raw materials. Also, the method of the present invention enables to prepare the high quality proteineous materials which has different physical properties compared to the proteineous materials by conventional method and enables to have the competitiveness in price by using rice bran which is a fourth price of the other raw materials.

Another objective of the present invention is to provide the protein extracts from the rice bran prepared according to the above method.

### [Technical Solution]

In order to accomplish the objectives, the present invention provides a preparation method of protein extracts from rice bran comprising:

a process of preparing the pellet from rice bran; a process of drying the pellet; a process of producing de-fatted rice bran by removing fat from the pellet; a process of extracting protein from the de-fatted rice bran, generating protein solution; and a process of precipitating protein from the protein solution; and a process of washing the precipitated protein, neutralizing and drying it to obtain final protein extracts from rice bran.

The preparation method of protein extracts from rice bran according to the present invention can be described in detail as follows:

The method of the present invention comprises a process of pre-treating rice bran, producing de-fatted rice bran; a process of extracting protein from the de-fatted rice bran generating protein solution; and a process of precipitating the protein to obtain final protein extracts from rice bran.

The process of pre-treating rice bran and producing de-fatted rice bran is to convert rice bran into de-fatted rice bran. By lowering the content of residual fat in the rice through the extraction of fat under the stable condition not occurring the denaturation of protein in the rice bran, the rice bran becomes desirable for extracting protein. Also, the process is to pelletize the rice bran, dry it and then extract fat from it recursively until the content of residual fat becomes 5%, more desirably 3% by adding 2-4 fold of n-hexane compared to the dried rice bran, and remove the residual hexane at below 60° C. It may take from hours to days to extract the fat depending on the system and apparatus of extraction/removal.

The process of extracting protein from the de-fatted rice bran to produce protein solution is to add 4-8 fold of water by weight, stir the mixture for 30-60 min to make the particles dispersed uniformly in the mixture by hydrolysis, and then extract protein by adding 1-5N of NaOH slowly at 20-50° C. until the final pH of the mixture is 8-10, generating the protein solution for 30-60 min. The important point in the process is to add the NaOH as slowly as possible in adjusting pH because the rapid addition of the NaOH may induce the darkening of the resultant protein.

After the extraction of protein, the protein solution is centrifuged at more than 5,000 g, ambient temperature. And the resultant supernatant becomes containing protein. Then, the supernatant is adjusted to pH 3-5 by adding 1-3N HCl, and maintained at 10-30° C. for 10-30 min to react it. During the reaction, protein at iso-electric point is precipitated and by centrifugation at more than 5,000 g, the final precipitated protein can be obtained.

The obtained protein is washed with 2-5 fold of water and then by re-centrifugation, the washed and precipitated protein can be obtained. When the protein is not washed completely, off-flavor may occur in the final product.

To the washed protein, 1-2 fold of water is added, producing the protein solution and then to the protein solution, less than 2N of NaOH was slowly added until its pH becomes 5-7, more desirably 6-7 for neutralization of the solution.

The neutralized protein solution is spray-dried under the conditions of inlet air temperature 150-190° C., outlet air temperature 70-100° C. and nozzle pressure 1.2-1.8 bar (10,000-20,000 RPM in case of atomizer type), and thus the final dried protein product is prepared. In the spray-drying, the temperature should be maintained constantly because rapid increase of the temperature may affect the quality of the product.

Additionally, the process of obtaining the washed and precipitated protein may be conducted by using decanter and high speed continuous centrifuge-type separator industrially.

The prepared protein extracts from rice bran can be used for supplementing protein and amino acid nutritionally in food or for improving physical property or quality in various foods such as dressing, mayonnaise, pudding, tofu, baby food, confectionery, bakery, etc.

### ADVANTAGEOUS EFFECTS

The method of the present invention makes it possible to obtain lipid from rice bran which has been wasted and used only as feed or compost due to fast rancidity and low stability even though it has good nutritional properties, and to ultimately develop proteineous materials of high quality, non-GMO and no-allergy by extracting protein from the rice bran without denaturation.

In addition, the present invention provides a method of recycling rice bran, which is wasted as a by-product, by adding values to the rice bran. And simultaneously the present invention provides new product which can meet the customers' needs for safety in proteineous materials.

As a result, new markets can be created through the proteineous materials and new model earning a lot can be created based on its competitive price.

### BEST MODE

The present invention is explained in detail by the following examples. However, the examples are provided for illustration of the present invention, not for limitation thereof.

### EXAMPLE 1

### The Preparation of the Protein Extracts from Rice Bran

1. Pre-Treatment of Rice Bran and Preparation of De-Fatted Rice Bran

Fresh rice bran containing 12-16% of moisture was obtained from a Nonghyup polishing plant in Korea and a big polishing plant in China. The rice bran was pelletized into the size of 2-10 mm using pellet-forming machine. The prepared rice bran pellet was dried until the content of moisture becomes less than 10%. To the dried rice bran pellet, 2-5 fold of hexane by weight compared to the rice bran by weight was added and circulative lipid-extraction is conducted until the content of residual oil in the rice bran becomes 3%. By removing the residual hexane at below 60° C., de-fatted rice bran was obtained.

2. The Protein Extraction from the De-Fatted Rice Bran

To the above de-fatted rice bran, 4-8 fold of water by weight was added and the mixture was stirred with shaking for 30-60 min in order to make the particles in the mixture uniformly dispersed. Subsequently, to the mixture, 3N of NaOH was slowly added at 20-30° C. in order to adjust the pH to 8-10 and then the mixture was kept for 30-60 min to extract protein.

3. The Preparation of the Final Protein Extracts from Rice Bran

After extraction of protein, the resultant protein solution was centrifuged at more than 5,000 g and ambient temperature, as a result thereof, the supernatant and the precipitate were obtained irrespectively. To the supernatant, 1-3N HCl was added at 10-30° C. in order to adjust its pH to 3.5-5.0 and then the supernatant was kept for less than 30 min to precipitate protein. And by centrifugation at more than 5,000 g, the precipitated protein was separated. To the precipitated protein, 2-5 fold of water was added for washing, and by re-centrifugation the washed and precipitated protein was obtained.

To the washed and precipitated protein, 1-2 fold of water was added in order to make the protein into the solution. To the resultant solution, 2N NaOH was slowly added to adjust its pH to 6-7 for neutralization. The neutralized protein solution was spray-dried under the condition of the inlet air temperature 150-190° C., the outlet air temperature 80-100° C. and the nozzle pressure 1.2-1.8 bar and finally the dried protein extract from rice bran was acquired. The condition of drying can be altered according to the capacity, type of apparatus.

### EXPERIMENTAL EXAMPLE 1

### The Analysis of the Protein Extracts Prepared According to Example 1

The General Components

The protein extracts from rice bran prepared according to Example 1 were analyzed and the analysis data were shown in table 1.

TABLE 1
The analysis data of the protein extracts from rice bran

| samples | moisture | protein | fat | ash | crude fiber |
|---|---|---|---|---|---|
| the present | 2.1 | 77.7 | 1.9 | 1.6 | 2.4 |
| invention 1 | | | | | |
| the present | 5.7 | 70.4 | 0.3 | 4.7 | 0.7 |
| invention 2 | | | | | |

As shown in table 1, it is verified technically that the protein extracts of high purity (protein 70%) from rice bran can be prepared according to the present invention, whereas the purity of the protein according to the previous other method is less than 40%.

### EXPERIMENTAL EXAMPLE 2

### The Comparison with Other Rice

The comparison of the general components between rice bran, the de-fatted rice bran (the present invention), white rice and brown rice was performed. The analysis data were shown in table 2.

TABLE 2
The comparison of the general components between rice
bran

| samples | moisture | protein | fat | ash | crude fiber |
|---|---|---|---|---|---|
| fresh rice | 10.59 | 14.03 | 19.15 | 7.14 | 9.29 |
| bran | | | | | |
| de-fatted | 12.3 | 17.98 | 0.9 | 11.93 | 8.1 |
| rice bran | | | | | |
| white rice | 13.07 | 5.9 | 0.47 | 0.43 | 0.5 |
| brown rice | 12.37 | 8.1 | 2.38 | 1.22 | 1.34 |

As shown in the above table 2, the content of protein in the de-fatted rice bran was 3 times higher than that of protein in the white rice, 2 times higher than that in the brown rice. Taking it into consideration that the price of white rice is 4 times more expensive than that of the de-fatted rice bran, it is estimated that using the de-fatted rice bran is more competitive in preparation of protein due to maximum 12 times of effect in lowering the price.

### EXPERIMENTAL EXAMPLE 3

### The Comparison on the Physical Properties

The physical properties of the protein extracts were analyzed and the comparisons with other rice protein products were done. The results are shown in table 3 and table 4.

TABLE 3
A comparison data of physical properties between proteins
with different originalities

| | the present | ISP isolated | ISP concentrated |
|---|---|---|---|
| physical properties | invention | soybean protein | soybean protein |
| emulsifying capacity | 750 | 645 | 450 |
| foam-producing capacity | 980 | 960 | — |
| foam stability | 86 | 4 | 2 |
| solubility | 36.1 | 33 | — |
| oil-binding capacity | 1.2 | 1.6 | 1.3 |

TABLE 4
The comparison of qualities between the protein products of
the present invention and of other overseas manufacturer

| | the | | | | |
|---|---|---|---|---|---|
| | present | manufacturer | manufacturer | manufacturer | manufacturer |
| qualities | invention | A(Pakistan) | B(U.S.A) | C(Europe) | C(China) |
| sensory | smooth | rough | rough | rough & | rough & |
| evaluation | mouth feel | | | off-flavor | off-flavor |
| emulsifying | High | Low | Low | Low | Low |
| capacity | | | | | |
| foam-producing | High | Low | Low | Low | Low |
| capacity | | | | | |
| foam stability | High | Low | Low | Low | Low |
| moisture- | Low | Low | Low | Low | Low |
| absorbing | | | | | |
| capacity | | | | | |
| gel-forming | Low | Low | Low | Low | Low |
| capacity | | | | | |

The protein extracts, prepared according to the present invention, showed discriminatively high emulsifying capacity, foam-producing capacity and foam stability. It indicates that the protein product in the present invention can be applied to various foods owing to its smoothness in mouth feel as well as foods (mayonnaise, pudding, dessert, etc.) requiring emulsifying capacity. But, other protein products showed very poor properties because of the denaturation of protein.

Besides, the preparation method of proteineous materials from rice bran and the proteineous materials thereof can be carried out in various converted ways. Thus, such converted performance should be interpreted as included in the scope of the right of the present invention.

1. A preparation method of protein extracts from rice bran, which is comprising:
pelletizing rice bran and drying it;
producing de-fatted rice bran by removing fat from the pellet;
extracting protein from the de-fatted rice bran to produce protein solution;
precipitating protein from the protein solution; and
washing, neutralizing and spray-drying the precipitated protein to prepare protein extracts.

2. The method according to claim 1, wherein the size of the pellet is 2-10 mm and the content of moisture is less than 10%.

3. The method according to claim 1, wherein the step of removing fat from the pellet is characterized in that 2-4 folds of n-hexane is added to the pellet and the extraction is conducted until the residual oil is less than 3%, and then the residual n-hexane is removed at below 55° C.

4. The method according to claim 1, wherein the step of extracting protein is characterized in that 4-8 fold of water is added to the de-fatted rice bran, and the mixture is hydrated for less than 60 min, and then to the mixture, 1-5N NaOH is added for adjusting its pH to 8-10 at 20-50° C., kept for 30-60 min.

5. The method according to claim 1, wherein the step of precipitating protein is characterized in that the protein solution is centrifuged, less than 3N NaOH is added to the resultant supernatant for adjusting its pH to 4-5 at 10-30° C., and the supernatant is added with 2-5 fold of water, centrifuged, washed and added with water to adjust its solid content to 5-20%, and then the supernatant is added with less than 2N NaOH at below 40° C. to adjust pH 5-7, preparing the neutralized protein solution.

6. The method according to claim 1, wherein the step of preparing protein extracts is characterized in that the neutralized protein solution is spray-dried under the condition of the inlet air temperature 150-190° C., the outlet air temperature 70-100° C., the nozzle pressure is 1.2-1.8 bar, and resulting the protein extracts.

7. The protein extracts from rice bran which is prepared by the method selected from any one of claim 1 to claim 6 and its protein content is 65-80%.
